(19) United States
(12) Patent Application Publication
(10) Pub. No.: US 2025/0283850 A1
(43) Pub. Date: Sep. 11, 2025

(54) PHYSICAL PROPERTY MEASUREMENT METHOD, PHYSICAL PROPERTY MEASUREMENT SYSTEM, AND ELEMENT FOR PHYSICAL PROPERTY MEASUREMENT

(71) Applicant: TOYO Corporation, Tokyo (JP)

(72) Inventors: Noriaki OYABU, Tokyo (JP); Masaru INOUE, Tokyo (JP); Hideyuki MURATA, Ishikawa (JP); Takuro IWATA, Ishikawa (JP)

(21) Appl. No.: 18/861,703

(22) PCT Filed: May 2, 2022
(86) PCT No.: PCT/JP2022/019537

§ 371 Date: Oct. 30, 2024

(51) Int. Cl. G01N 27/48

(52) U.S. Cl. CPC G01N 27/48

(57) ABSTRACT

A physical property measurement method includes applying a voltage, which periodically varies and periodically reverses in polarity, between a pair of electrodes in an element for physical property measurement. The element for physical property measurement includes: a material to be measured; an insulation layer disposed on only one of both sides of the material to be measured in a thickness direction thereof; and the pair of electrodes between which the material to be measured and the insulation layer are interposed in the thickness direction. The physical property measurement method also includes measuring a physical property of the material to be measured based on a current flowing through the element for physical property measurement as a result of the application of the voltage. The measuring of the physical property of the material to be measured includes measuring a polarity of an ion contained in the material to be measured.

### TECHNICAL FIELD

The present disclosure relates to a physical property measurement method, a physical property measurement system, and an element for physical property measurement, for measuring a physical property of a material to be measured.

### BACKGROUND ART

Patent Literature (PTL) 1 discloses a method for measuring impurity ions in a liquid by applying a triangular wave voltage signal between a first electrode and a second electrode with the liquid being sealed in a measuring container including the first electrode and the second electrode, and detecting a current signal flowing through the liquid in accordance with the application of the triangular wave voltage signal.

Non Patent Literature (NPL) 1 discloses a method for measuring an ion impurity amount in green thermally activated delayed fluorescence (TADF) dopant powder by sealing a xylene solution containing the TADF dopant powder in a test cell, applying a triangle waveform voltage to this test cell, and measuring the current.

NPL 2 discloses a technique in which an electron only device made of tris-(8-hydroxyquinolate) (Alq) aluminum or tris(7-propyl-8-hydroxyquinolinato) aluminum (Al7p) is prepared and an impact of polarization charge on electron injection from a cathode is evaluated by displacement current measurement (DCM).

### CITATION LIST

### Patent Literature

### [PTL 1]

WO2019/167186

### Non Patent Literature

### [NPL 1]

Inoue M, Oyabu N, Kaneko Y, Kim J-Y, Yang J-H. Correlation between ion impurity in thermally activated delayed fluorescence organic light-emitting diode materials and device lifetime. J. Soc Inf Disp. 2020; 28(11); 905-910.

### [NPL 2]

Tanaka Y, Makino T, Ishii H. Influence of Polarity of Polarization Charge Induced by Spontaneous Orientation of Polar Molecules on Electron Injection in Organic Semiconductor Devices. IEICE Transactions on Electronics, issue 2, pp. 172-175. February 2019

### SUMMARY OF INVENTION

### Technical Problem

A problem with each of the technologies disclosed in PTL 1, NPL 1, and NPL 2 described above is that a polarity of ions contained in a material to be measured, which is a solid, cannot be measured.

In view of this, the present disclosure provides a physical property measurement method, a physical property measurement system, and an element for physical property measurement, capable of measuring a polarity of ions contained in a material to be measured, which is a solid.

### Solution to Problem

In order to achieve the object described above, a physical property measurement method according to one aspect of the present disclosure includes: applying a voltage between a pair of electrodes in an element for physical property measurement, the voltage periodically varying and periodically reversing in polarity, the element for physical property measurement including: a material to be measured, the material being a solid; an insulation layer disposed on only one of both sides of the material to be measured in a thickness direction of the material to be measured; and the pair of electrodes between which the material to be measured and the insulation layer are interposed in the thickness direction; and measuring a physical property of the material to be measured based on a current flowing through the element for physical property measurement as a result of the applying of the voltage. The measuring of the physical property of the material to be measured includes measuring a polarity of an ion contained in the material to be measured.

In order to achieve the object described above, a physical property measurement system according to one aspect of the present disclosure includes: a voltage applier and a measurer. The voltage applier applies a voltage between a pair of electrodes in an element for physical property measurement, the voltage periodically varying and periodically reversing in polarity, the element for physical property measurement including: a material to be measured, the material being a solid; an insulation layer disposed on only one of both sides of the material to be measured in a thickness direction of the material to be measured; and the pair of electrodes between which the material to be measured and the insulation layer are interposed in the thickness direction. The measurer measures a physical property of the material to be measured based on a current flowing through the element for physical property measurement as a result of the voltage applied. The measurer measures a polarity of an ion contained in the material to be measured.

In order to achieve the object described above, the element for physical property measurement according to one aspect of the present disclosure is used in the physical property measurement system.

### Advantageous Effects of Invention

The physical property measurement method, etc. according to the present disclosure have an advantage of being able to measure the polarity of the ion contained in the material to be measured, which is a solid.

### BRIEF DESCRIPTION OF DRAWINGS

FIG. 1 is a schematic diagram illustrating a configuration of a physical property measurement system according to an embodiment.

FIG. 2 is a schematic diagram illustrating an element for physical property measurement according to the embodiment.

FIG. 3 is a schematic diagram illustrating an element for physical property measurement according to a comparative example.

FIG. 4 is a diagram showing an example of a graph of voltage (time) versus current plots obtained by measuring a displacement current that flows when a triangle waveform voltage is applied to the element for physical property measurement according to the comparative example.

FIG. 5 is a flowchart showing an example of a physical property measurement method according to the embodiment.

FIG. 6 is a diagram showing an example of measurement results of a sublimated material to be measured, obtained by using the physical property measurement method according to the embodiment.

FIG. 7 is a diagram showing an example of measurement results of an unpurified material to be measured, obtained by using the physical property measurement method according to the embodiment.

FIG. 8 is a diagram showing temperature dependency of ion amount measurement using the physical property measurement method according to the embodiment.

FIG. 9 is a diagram showing a comparative example between measurement results of a material to be measured before sublimation and those of the material to be measured after sublimation, obtained by using the physical property measurement method according to the embodiment.

### DESCRIPTION OF EMBODIMENTS

Embodiments will be specifically described below with reference to the drawings.

Each of the embodiments described below shows a general or specific example. The numerical values, shapes, materials, elements, the arrangement and connection of the elements, etc. shown in the following embodiments are mere examples, and therefore do not limit the scope of the appended Claims. Among the elements in the following embodiments, those not recited in any one of the independent claims indicating the most superordinate concept are described as optional elements. In addition, each of the figures is not necessarily drawn in a strict manner. Substantially the same configurations are denoted by the same reference numeral throughout the figures, and redundant descriptions are omitted or simplified.

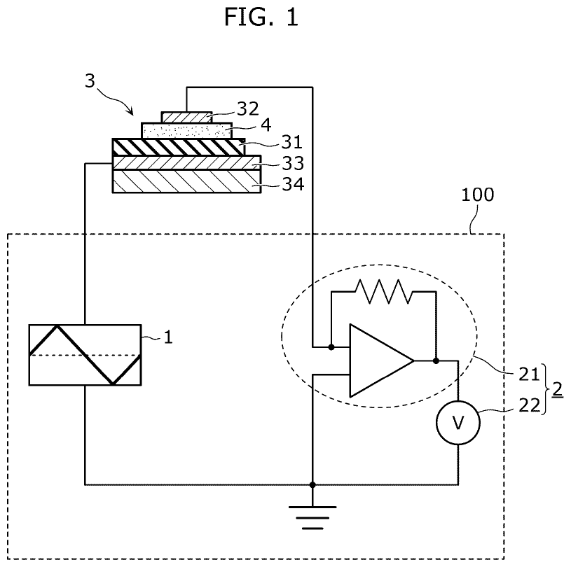

FIG. 1 is a schematic diagram illustrating a configuration of physical property measurement system 100 according to an embodiment. A physical property measurement method and physical property measurement system 100 according to the embodiment measure a polarity of ions (ion impurities) contained in material 4 to be measured, which is a solid. Specifically, in the physical property measurement method and physical property measurement system 100 according to the embodiment, ion impurities contained in material 4 to be measured are measured by applying a voltage between a pair of electrodes 32 and 33 (described later) included in element 3 for physical property measurement, including material 4 to be measured, which is a thin film.

As shown in FIG. 1, physical property measurement system 100 includes voltage applier 1 and measurer 2.

Voltage applier 1 is connected between the pair of electrodes 32 and 33 included in element 3 for physical property measurement. Voltage applier 1 applies, between the pair of electrodes 32 and 33, a voltage that periodically varies and periodically reverses in polarity. According to the embodiment, voltage applier 1 is a function generator, which generates a triangle waveform voltage as the voltage that periodically varies and periodically reverses in polarity, and applies the generated triangle waveform voltage between the pair of electrodes 32 and 33. As an example, the triangle waveform voltage has a frequency of 0.001 Hz and an amplitude of ±10 V.

Note that the frequency and the amplitude of the triangle waveform voltage are each a mere example, and the present disclosure is not limited thereto. Note however that a relatively low frequency is preferred as the frequency of the triangle waveform voltage. This is because a higher frequency of the triangle waveform voltage leads to the reversal of polarity of the voltage before the ions contained in material 4 to be measured reach insulation layer 31 (described later), and therefore a current caused by the ions to be measured can no longer be measured.

Measurer 2 measures physical properties of material 4 to be measured based on a current flowing through element 3 for physical property measurement as a result of the application of the voltage by voltage applier 1. According to the embodiment, the physical properties of material 4 to be measured include at least a polarity of the ions contained in material 4 to be measured. According to the embodiment, the physical properties of material 4 to be measured also include an amount of the ions contained in material 4 to be measured.

According to the embodiment, measurer 2 includes I-V converter 21 and voltmeter 22. I-V converter 21 is connected in series with the pair of electrodes 32 and 33 in element 3 for physical property measurement, and converts the current flowing through element 3 for physical property measurement into voltage. Voltmeter 22 measures the voltage converted by I-V converter 21. Specifically, measurer 2 measures the current flowing through element 3 for physical property measurement by measuring the voltage converted by I-V converter 21 with voltmeter 22.

Although the details are described later, measurer 2 measures the polarity and the amount of the ions contained in material 4 to be measured by measuring the current flowing through element 3 for physical property measurement.

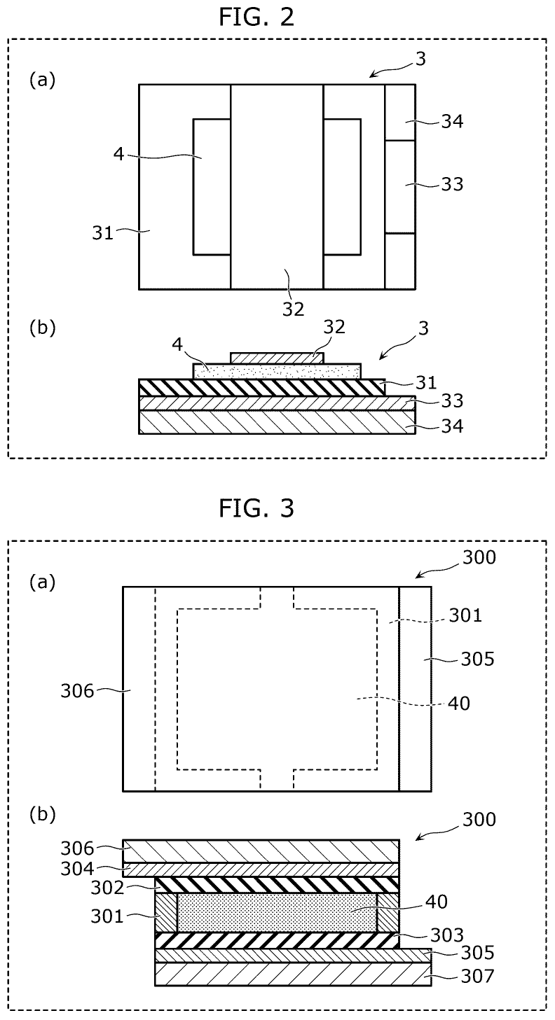

FIG. 2 is a schematic diagram illustrating element 3 for physical property measurement according to the embodiment. (a) in FIG. 2 shows a plan view of element 3 for physical property measurement, and (b) in FIG. 2 shows a cross-sectional view of element 3 for physical property measurement. As shown in FIG. 2, element 3 for physical property measurement includes insulation layer 31, the pair of electrodes 32 and 33, glass substrate 34, and material 4 to be measured. According to the embodiment, element 3 for physical property measurement is in the shape of a several centimeters square in planar view.

Insulation layer 31 is a silicon nitride (SiN) insulation film. Note that the material that forms insulation layer 31 is not limited to any particular material. For example, insulation layer 31 may be a polyimide insulation film. Insulation layer 31 is provided on a surface (here, an upper surface) of electrode 33, which is one (here, lower one) of the pair of electrodes 32 and 33. Material 4 to be measured is disposed on a surface (here, an upper surface) of insulation layer 31 closer to electrode 32, which is the other (here, upper one) of the pair of electrodes 32 and 33.

Electrode 32, which is one (here, upper one) of the pair of electrodes 32 and 33, is an aluminum (Al) electrode. Electrode 33, which is the other (here, lower one) of the pair of electrodes 32 and 33, is an indium tin oxide (ITO) electrode, which is a transparent electrode. The materials that form the pair of electrodes 32 and 33 are not limited to any particular materials.

Electrode 32, which is one (here, upper one) of the pair of electrodes 32 and 33, is disposed on a surface (here, an upper surface) of material 4 to be measured. Electrode 33, which is the other (here, lower one) of the pair of electrodes 32 and 33, is provided on a surface (here, an upper surface) of glass substrate 34. In the pair of electrodes 32 and 33, parts of electrodes 32 and 33 are externally exposed, and voltage applier 1 and measurer 2 can be electrically connected to the exposed portions via electric wires.

As described above, insulation layer 31 is disposed on only one side (here, a lower side) of both sides of material 4 to be measured in a thickness direction (here, an up-down direction). The pair of electrodes 32 and 33 are disposed to interpose material 4 to be measured and insulation layer 31 therebetween in the thickness direction. Therefore, a surface (here, a lower surface) of material 4 to be measured in the thickness direction is in contact with insulation layer 31, and the other surface (here, the upper surface) of material 4 to be measured is in contact with electrode 32 without an insulation layer being interposed therebetween.

According to the embodiment, a dimension of electrode 32, a dimension of material 4 to be measured, a dimension of insulation layer 31, and a dimension of electrode 33 in a horizontal direction (here, a left-right direction) of element 3 for physical property measurement become larger in this order, but this is not intended to limit the dimensions in the horizontal direction. According to the embodiment, in a vertical direction (here, a depth direction of the paper) of element 3 for physical property measurement, a dimension of material 4 to be measured is smaller than dimensions of electrode 32 and insulation layer 31, but this is not intended to limit the dimensions in the vertical direction.

Material 4 to be measured is, for example, an organic material such as poly (3-hexylthiophene) (P3HT) used as a material for organic photovoltaics, or a material used for hole transport layers (HTLs) of organic electroluminescence (EL) devices. According to the embodiment, material 4 to be measured is α-NPD, which is a material used for HTLs of organic EL devices. Note that material 4 to be measured may be a material used for electron transport layers (ETLs) of organic EL devices. Material 4 to be measured may be an organic material or an inorganic material, for example.

According to the embodiment, material 4 to be measured is a solid, in particular, a thin film. A thickness of material 4 to be measured is tens of nanometers in the embodiment, but may be hundreds of nanometers. Note that material 4 to be measured needs to be a solid but needs not be a thin film.

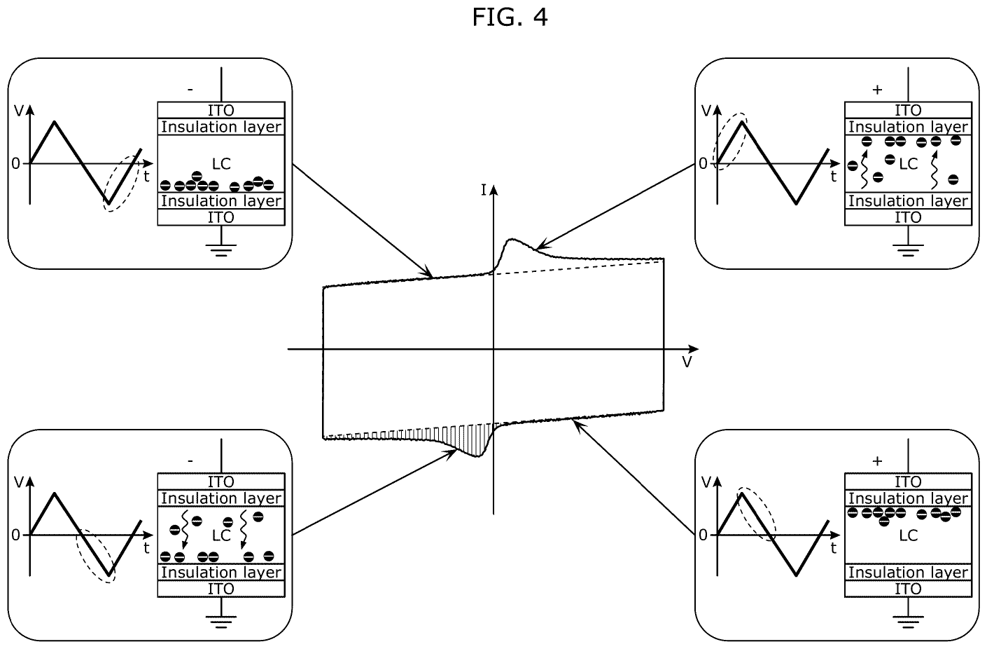

Differences in characteristics between element 3 for physical property measurement according to the embodiment and element 300 for physical property measurement according to a comparative example will now be described with reference to FIGS. 3 and 4. First, a configuration of element 300 for physical property measurement according to the comparative example will be described with reference to FIG. 3. FIG. 3 is a schematic diagram illustrating element 300 for physical property measurement according to the comparative example. (a) in FIG. 3 is a plan view of element 300 for physical property measurement according to the comparative example, and (b) in FIG. 3 is a cross-sectional view of element 300 for physical property measurement according to the comparative example.

As shown in FIG. 3, element 300 for physical property measurement according to the comparative example includes: seal material 301, a pair of insulation films 302 and 303, a pair of electrodes 304 and 305, a pair of glass substrates 306 and 307, and sample 40. Sample 40 is prepared by mixing a material to be measured with liquid crystal.

Each of the pair of electrodes 304 and 305 is an ITO electrode, which is a transparent electrode. Electrode 304, which is one (here, upper one) of the pair of electrodes 304 and 305, is provided on a surface (here, a lower surface) of glass substrate 306, which is one (here, upper one) of the pair of glass substrates 306 and 307. Electrode 305, which is the other (here, lower one) of the pair of electrodes 304 and 305, is provided on a surface (here, an upper surface) of glass substrate 307, which is the other (here, lower one) of the pair of glass substrates 306 and 307.

Each of the pair of insulation films 302 and 303 is a silicon nitride (SiN) insulation film. Insulation film 302, which is one (here, upper one) of the pair of insulation films 302 and 303, is provided on a surface (here, a lower surface) of electrode 304, which is one (here, upper one) of the pair of electrodes 304 and 305. Insulation film 303, which is the other (here, lower one) of the pair of insulation films 302 and 303, is provided on a surface (here, an upper surface) of electrode 305, which is the other (here, lower one) of the pair of electrodes 304 and 305. The pair of insulation films 302 and 303 are disposed facing each other with a space in which sample 40 is sealed being interposed therebetween.

Seal material 301 is applied between the pair of insulation films 302 and 303, the pair of electrodes 304 and 305, and the pair of glass substrates 306 and 307 to cover the space described above. In other words, the space described above is formed by the pair of insulation films 302 and 303, the pair of electrodes 304 and 305, the pair of glass substrates 306 and 307, and seal material 301. Note that a part of each of the pair of electrodes 304 and 305 is externally exposed, and voltage applier 1 and measurer 2 can be electrically connected to the exposed portions via electric wires.

The material to be measured is, for example, a material used for HTLs of organic EL devices. In the comparative example, the material to be measured, which is mixed with liquid crystal, is in the form of granules, powder, or liquid.

As described above, element 300 for physical property measurement according to the comparative example differs from element 3 for physical property measurement according to the embodiment in that sample 40 prepared by mixing the material to be measured with liquid crystal is included instead of material 4 to be measured, which is a solid. In addition, element 300 for physical property measurement according to the comparative example differs from element 3 for physical property measurement according to the embodiment in that insulation films 302 and 303 are disposed on both sides of sample 40 in a thickness direction (here, an up-down direction) of sample 40.

FIG. 4 is a diagram showing an example of a graph of voltage V (time) versus current I plots (V-I curve) obtained by measuring a displacement current that flows when a triangle waveform voltage is applied to element 300 for physical property measurement according to the comparative example. Here, it is assumed that sample 40 of element 300 for physical property measurement contains anions as ions.

In FIG. 4, the reciprocal of a slope with respect to a V-axis represents resistance of sample 40. In FIG. 4, a vertical width of the graph in the shape of a parallelogram in an I-axis direction represents capacitance of sample 40. In FIG. 4, the area of a peak protruding from the graph in the shape of a parallelogram represents an amount of ions (anions) contained in sample 40. Such a peak appears not only in the first quadrant but also in the third quadrant.

As shown in FIG. 4, when element 300 for physical property measurement according to the comparative example is used, the physical property of the anions (ions) contained in the material to be measured appears in the measurement result of the displacement current as a physical property of the material to be measured.

As shown in the first quadrant in FIG. 4, a peak of the displacement current occurs in a period in which the voltage applied to element 300 for physical property measurement according to the comparative example transitions from negative voltage to positive voltage. This peak of the displacement current is observed as a result of the anions migrating to a surface of insulation film 302, which is one of the pair of insulation films 302 and 303 and is disposed on the side of electrode 304 that is one of the pair of electrodes 304 and 305 to be a positive electrode during this period.

As shown in the third quadrant in FIG. 4, a peak of the displacement current also occurs in a period in which the voltage applied to element 300 for physical property measurement according to the comparative example transitions from positive voltage to negative voltage. This peak of the displacement current is observed as a result of the anions migrating to a surface of insulation film 303, which is the other of the pair of insulation films 302 and 303 and is disposed on the side of electrode 305 that is the other of the pair of electrodes 304 and 305 to be a positive electrode during this period.

By the way, these displacement current peaks are similarly observed when ions contained in the material to be measured are cations. In other words, such displacement current peaks are observed regardless of a polarity of ions contained in the material to be measured. Therefore, in measurement using element 300 for physical property measurement according to the comparative example, whether the ions contained in the material to be measured are anions or cations, i.e., the polarity of the ions, cannot be measured.

When element 3 for physical property measurement according to the embodiment is used, on the other hand, the polarity of the ions contained in material 4 to be measured can be measured. This will be described below in detail under the headings of <Method>and <Advantages>.

### <Method>

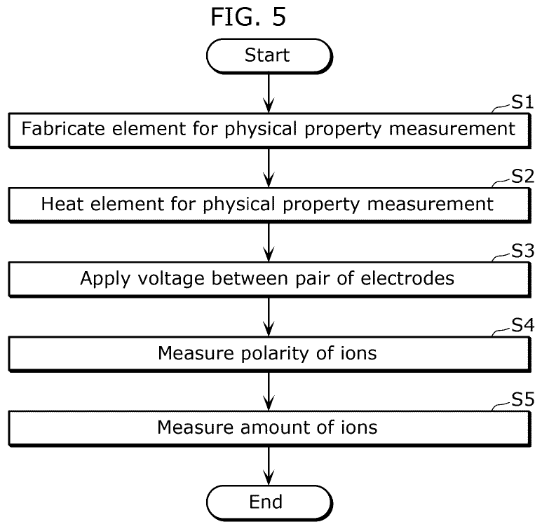

Operations of physical property measurement system 100 according to the embodiment, i.e., the physical property measurement method, will be described below with reference to FIG. 5. FIG. 5 is a flowchart showing an example of the physical property measurement method according to the embodiment.

First, element 3 for physical property measurement is fabricated (step S1). Specifically, the element is fabricated by layering electrode 33, insulation layer 31, a thin film of material 4 to be measured, and electrode 32 in this order on a surface (here, an upper surface) of glass substrate 34.

Next, element 3 for physical property measurement is heated (step S2). Here, element 3 for physical property measurement is heated until an ambient temperature of element 3 for physical property measurement reaches about 40 to 80 degrees Celsius. Subsequently, while heating element 3 for physical property measurement or with element 3 for physical property measurement being placed in a high-temperature environment, a voltage (here, a triangle waveform voltage) is applied between the pair of electrodes 32 and 33 in element 3 for physical property measurement by voltage applier 1 (step S3). Specifically, according to the embodiment, step S3 in which the voltage is applied between the pair of electrodes 32 and 33 is performed at a temperature (here, about 40 to 80 degrees Celsius) higher than room temperature.

It can be considered that heating element 3 for physical property measurement as just described can improve mobility of the ions contained in material 4 to be measured. In step S5 (described later) in which an amount of the ions in material 4 to be measured is measured, measurement accuracy of the amount of the ions contained in material 4 to be measured can be further improved as compared to a case where no element 3 for physical property measurement is heated.

Next, a current flowing between the pair of electrodes 32 and 33 in element 3 for physical property measurement is measured by measurer 2, and the polarity of the ions contained in material 4 to be measured is measured based on the measured current (step S4). In addition, the amount of the ions contained in material 4 to be measured is measured based on the measured current (step S5).

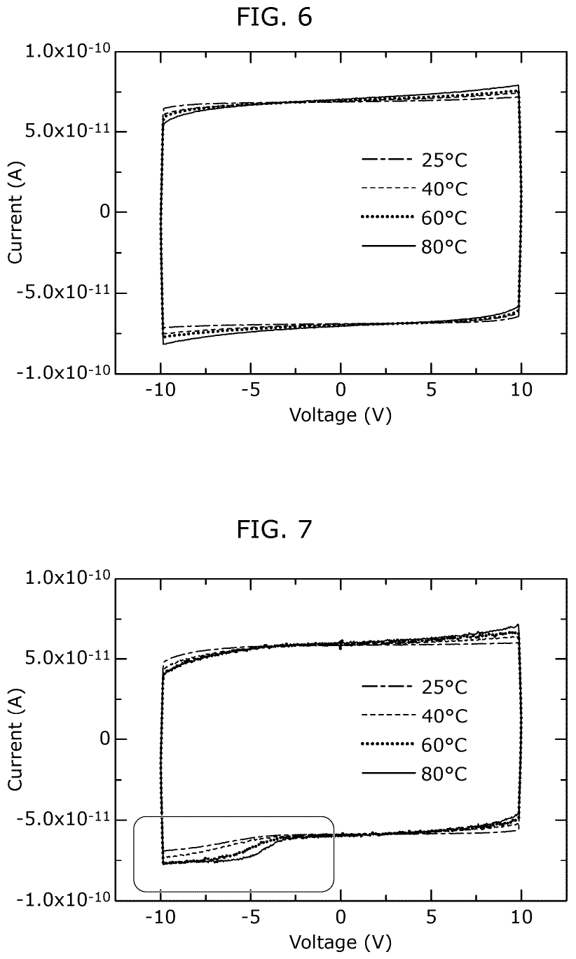

Specific examples of measuring the polarity and the amount of the ions contained in material 4 to be measured will now be described with reference to FIGS. 6 and 7. FIG. 6 is a diagram showing an example of measurement results of sublimated material 4 to be measured, obtained by using the physical property measurement method according to the embodiment. FIG. 7 is a diagram showing an example of measurement results of unpurified material 4 to be measured, obtained by using the physical property measurement method according to the embodiment. Specifically, FIG. 6 shows the measurement results of material 4 to be measured, from which impurities have been removed through sublimation, and FIG. 7 shows the measurement results of material 4 to be measured, from which no impurities have been removed.

In the measurement results shown in FIGS. 6 and 7, a vertical axis represents current (unit: “A”) flowing through the pair of electrodes 32 and 33 and element 3 for physical property measurement, and a horizontal axis represents voltage (unit: “V”) applied between the pair of electrodes 32 and 33. In FIGS. 6 and 7, a dash-dotted line represents measurement results at room temperature (here, 25 degrees Celsius), a broken line represents measurement results when element 3 for physical property measurement has been heated to 40 degrees Celsius, a dotted line represents measurement results when element 3 for physical property measurement has been heated to 60 degrees Celsius, and a solid line represents measurement results when element 3 for physical property measurement has been heated to 80 degrees Celsius.

As shown in FIG. 6, for the measurement results of sublimated material 4 to be measured, peaks slightly protruding from the graph in the shape of a parallelogram appear both in the first quadrant and the third quadrant, but no significant difference can be observed therebetween. As shown in FIG. 7, for the measurement results of unpurified material 4 to be measured, on the other hand, peaks protruding from the graph in the shape of a parallelogram prominently appear especially in the third quadrant (see the inside of the rectangular box in FIG. 7). Such a peak becomes more prominent as the temperature of element 3 for physical property measurement increases.

Therefore, by calculating the area of a region including such a peak, the amount of the ions (ion impurities) contained in material 4 to be measured can be measured. This peak appears prominently in the third quadrant, i.e., in a period when the voltage applied to element 3 for physical property measurement transitions from positive voltage to negative voltage. Specifically, this peak is observed as a result of the ions migrating to a surface of insulation layer 31 disposed on the side of electrode 33, which is one of the pair of electrodes 32 and 33 to be a negative electrode during this period. Therefore, it is possible to measure that the ions (ion impurities) contained in material 4 to be measured are cations.

The reason why no peak appears in the first quadrant is because no insulation layer is disposed on the side of electrode 32. Specifically, in the first quadrant, i.e., in a period when the voltage applied to element 3 for physical property measurement transitions from negative voltage to positive voltage, electrode 32 out of the pair of electrodes 32 and 33 becomes a negative electrode, but the ions contained in material 4 to be measured are not detected because no insulation layer is disposed on the side of electrode 32. Therefore, no peak is observed in the first quadrant.

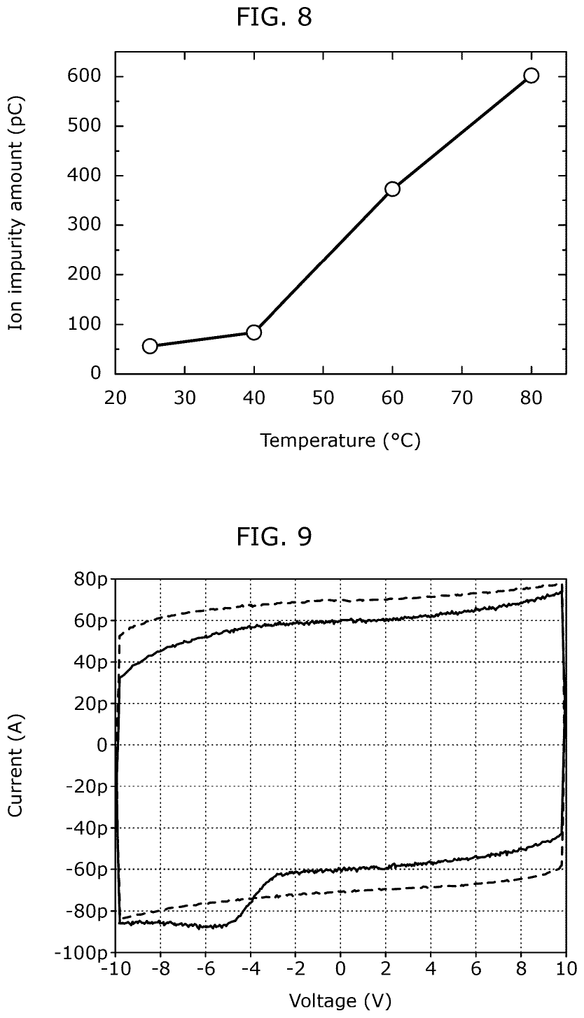

As described above, such a peak becomes more prominent as the temperature of element 3 for physical property measurement increases. FIG. 8 is a diagram showing temperature dependency of ion amount measurement using the physical property measurement method according to the embodiment. In FIG. 8, a vertical axis represents a measured ion (ion impurity) amount (unit: “pC”), and a horizontal axis represents temperature (unit: degree Celsius) of element 3 for physical property measurement. As shown in FIG. 8, the measured ion amount increases significantly as the temperature of element 3 for physical property measurement increases to 40 degrees Celsius, 60 degrees Celsius, and 80 degrees Celsius. In other words, raising the temperature of element 3 for physical property measurement facilitates the measurement of the amount of the ions contained in material 4 to be measured.

FIG. 9 is a diagram showing a comparative example between measurement results of material 4 to be measured before sublimation and those of material 4 to be measured after sublimation, obtained by using the physical property measurement method according to the embodiment. In the measurement results shown in FIG. 9, a vertical axis represents current (unit: “A”) flowing through the pair of electrodes 32 and 33 and element 3 for physical property measurement, and a horizontal axis represents voltage (unit: “V”) applied between the pair of electrodes 32 and 33. In FIG. 9, a broken line represents measurement results of unpurified material 4 to be measured, and a solid line represents measurement results of sublimated material 4 to be measured. The measurement results shown in FIG. 9 are measurement results obtained when the temperature of element 3 for physical property measurement has been heated to 80 degrees Celsius. As shown in FIG. 9, a peak caused by the ions (ion impurities) contained in material 4 to be measured can be observed in the first quadrant or the third quadrant (here, the third quadrant) by using the physical property measurement method according to the embodiment.

By the way, if ions contained in material 4 to be measured are anions, a peak protruding from a graph in the shape of a parallelogram would prominently appear in the first quadrant instead of the third quadrant. Specifically, in the period when the voltage applied to element 3 for physical property measurement transitions from negative voltage to positive voltage, electrode 33 out of the pair of electrodes 32 and 33 becomes a negative electrode. Therefore, the peak is observed as a result of the ions migrating to the surface of insulation layer 31 disposed on the side of electrode 33 during this period. Therefore, in this case, it is possible to measure that the ions (ion impurities) contained in material 4 to be measured are anions.

### <Advantages>

Advantages of the physical property measurement method and physical property measurement system 100 according to the embodiment will be described below. First, the technical background that has led to the measurement of a polarity and an amount of ions contained in material 4 to be measured, as in the physical property measurement method and physical property measurement system 100 according to the embodiment, will be described.

If impurities are contained in an organic material, it has been conventionally known that the impurities adversely affect performance and durability of a device, such as an organic EL display, manufactured using the organic material. The impurities may be organic or inorganic ion impurities, for example. Thus, in fabricating a device such as an organic EL display, it is important to measure whether an organic material used to fabricate the device contains ion impurities. Especially in the device such as the organic EL display, the organic material is used in the form of a thin film, i.e., in the form of a solid. Thus, it is important to measure whether the organic material, which is a solid, contains ion impurities.

On the other hand, techniques for detecting whether material 4 to be measured contains ion impurities using an electroanalytical technique for measuring an electric charge quantity in material 4 to be measured have been known, and such techniques are disclosed in PTL 1 and NPL 1, for example.

As mentioned in the section of Background Art, PTL 1 discloses a method for measuring impurity ions in a liquid by applying a triangular wave voltage signal between a first electrode and a second electrode with the liquid being sealed in a measuring container including the first electrode and the second electrode, and detecting a current signal flowing through the liquid in accordance with the application of the triangular wave voltage signal. As mentioned in the section of Background Art, NPL 1 discloses a method for measuring an ion impurity amount in green TADF dopant powder by sealing a xylene solution containing the TADF dopant powder in a test cell, applying a triangle waveform voltage to this test cell, and measuring the current.

However, according to each of the technologies disclosed in PTL 1 and NPL 1, the measurement needs to be performed with a material to be measured being mixed with a liquid or a solvent due to the structure of the measuring container or the test cell. Thus, a problem with the technologies disclosed in PTL 1 and NPL 1 is that the measurement cannot be performed when a material to be measured is a solid. This is because such a material to be measured cannot be sealed in the measuring container or the test cell. Another problem with the technologies disclosed in PTL 1 and NPL 1 is that a polarity of ions contained in a material to be measured cannot be measured in the first place.

On the other hand, the inventors of the present application have found that ions contained in material 4 to be measured, which is a solid, can be detected by applying a voltage (here, a triangle waveform voltage), which periodically varies and periodically reverses in polarity, between the pair of electrodes 32 and 33 in element 3 for physical property measurement including: material 4 to be measured, which is a solid; insulation layer 31 disposed on only one of both sides of material 4 to be measured in the thickness direction thereof; and the pair of electrodes 32 and 33 between which material 4 to be measured and insulation layer 31 are interposed in the thickness direction. The inventors of the present application have also found that by disposing insulation layer 31 only on the one side described above in element 3 for physical property measurement, the position where the peak of the current flowing through element 3 for physical property measurement in accordance with the application of the voltage appears indicates the polarity of the ions contained in material 4 to be measured.

Thus, with the physical property measurement method and physical property measurement system 100 according to the embodiment, a polarity and an amount of ions contained in material 4 to be measured, which is a solid, can be measured, which is impossible with the technologies disclosed in PTL 1 and NPL 1. Specifically, with the physical property measurement method and physical property measurement system 100 according to the embodiment, a polarity and an amount of ions (ion impurities) contained in material 4 to be measured in very minute amounts (e.g., a few pC) can be measured.

As mentioned in the section of Background Art, NPL 2 discloses a technique in which an electron only device made of tris-(8-hydroxyquinolate) aluminum (Alq) or tris(7-propyl-8-hydroxyquinolinato) aluminum (Al7p) is prepared and an impact of polarization charge on electron injection from a cathode is evaluated by displacement current measurement. This electron only device has a structure in which an organic material layer and an insulation layer are disposed between a pair of electrodes, which is similar to the structure of element 3 for physical property measurement disclosed in the present application.

However, an object of the electron only device disclosed in NPL 2 is to evaluate the impact of polarization charge on electron injection from the cathode as described above, and is not to detect ions contained in material 4 to be measured as in the physical property measurement method disclosed in the present application. Also, the insulation layer of the electron only device disclosed in NPL 2 is used to block charges (holes) injected from a silicon substrate (electrode), i.e., to control the injection of the charges, and is not used to measure the ions contained in material 4 to be measured as in insulation layer 31 of element 3 for physical property measurement. In the displacement current measurement in NPL 2, the frequency of the applied voltage is 20 mHz, which is a very high frequency as compared to the frequency (1 mHz) of the applied voltage in the physical property measurement method disclosed in the present application. Furthermore, in the displacement current measurement in NPL 2, an alternating voltage whose polarity is not periodically reversed is applied to the electron only device, and a voltage whose polarity is periodically reversed such as the applied voltage in the physical property measurement method disclosed in the present application is not applied.

In other words, although NPL 2 discloses the electron only device having the structure similar to that of element 3 for physical property measurement disclosed in the present application, the object of the measurement using the electron only device in NPL 2 is entirely different from the object of the physical property measurement method disclosed in the present application. Moreover, the conditions of the voltage applied to the electron only device in NPL 2 are also entirely different from those in the physical property measurement method disclosed in the present application. Therefore, it is evident that those skilled in the art, having read NPL 2, would not easily conceive the physical property measurement method disclosed in the present application.

As described above, the physical property measurement method and physical property measurement system 100 according to the embodiment have an advantage of being able to measure a polarity of ions contained in material 4 to be measured, which is a solid, and such an advantage is impossible with the technologies disclosed in PTL 1, NPL 1, and NPL 2. In addition, the physical property measurement method and physical property measurement system 100 according to the embodiment have a further advantage of being able to measure an amount of ions contained in material 4 to be measured, which is a solid.

### (Variations)

The physical property measurement method and physical property measurement system 100 according to the present disclosure have been described above with reference to the embodiment, but the present disclosure is not limited to the embodiment. Forms obtained by making various modifications to the embodiment that can be conceived by those skilled in the art, or other forms constructed by combining some of the structural components in the embodiment, without materially departing from the spirit of the present disclosure, may be included in the scope of the present disclosure.

In the embodiment described above, step S3 in which the voltage is applied between the pair of electrodes 32 and 33 in element 3 for physical property measurement is performed at a temperature higher than room temperature. However, the present disclosure is not limited thereto. For example, step S3 described above may be performed at room temperature.

In the embodiment described above, the physical property measurement method and physical property measurement system 100 measure both the polarity and the amount of the ions contained in material 4 to be measured. However, the present disclosure is not limited thereto. For example, the physical property measurement method and physical property measurement system 100 may measure only the polarity of the ions contained in material 4 to be measured.

In the embodiment described above, insulation layer 31 of element 3 for physical property measurement is disposed between electrode 33, which is one of the pair of electrodes 32 and 33 on the side of glass substrate 34, and material 4 to be measured. However, the present disclosure is not limited thereto. For example, insulation layer 31 may be disposed between electrode 32, which is one of the pair of electrodes 32 and 33 on the side where no glass substrate 34 is disposed, and material 4 to be measured.

### (Brief Overview)

As described above, the physical property measurement method according to the present disclosure includes: applying (step S3) a voltage between the pair of electrodes 32 and 33 in element 3 for physical property measurement, the voltage periodically varying and periodically reversing in polarity, element 3 for physical property measurement including: material 4 to be measured, which is a solid; insulation layer 31 disposed on only one of both sides of material 4 to be measured in the thickness direction thereof; and the pair of electrodes 32 and 33 between which material 4 to be measured and insulation layer 31 are interposed in the thickness direction; and measuring a physical property of material 4 to be measured based on a current flowing through element 3 for physical property measurement as a result of the applying of the voltage. The measuring of the physical property of material 4 to be measured includes measuring a polarity of ions contained in material 4 to be measured (step S4).

According to this, there is provided an advantage of being able to measure the polarity of the ions contained in material 4 to be measured, which is a solid.

In the physical property measurement method according to the present disclosure, the measuring of the physical property of the material to be measured further includes measuring an amount of the ions contained in material 4 to be measured.

According to this, there is provided an advantage of being able to measure the amount of the ions contained in material 4 to be measured, which is a solid.

In the physical property measurement method according to the present disclosure, step S3 of applying the voltage between the pair of electrodes 32 and 33 is performed at a temperature higher than room temperature (step S3).

According to this, there is provided an advantage of being able to improve mobility of the ions contained in material 4 to be measured, and thus being able to further improve measurement accuracy of the amount of the ions contained in material 4 to be measured.

Physical property measurement system 100 according to the present disclosure includes: voltage applier 1 and measurer 2. Voltage applier 1 applies a voltage between the pair of electrodes 32 and 33 in element 3 for physical property measurement. The voltage periodically varies and periodically reverses in polarity. Element 3 for physical property measurement includes: material 4 to be measured, which is a solid; insulation layer 31 disposed on only one of both sides of material 4 to be measured in the thickness direction thereof; and the pair of electrodes 32 and 33 between which material 4 to be measured and insulation layer 31 are interposed in the thickness direction. Measurer 2 measures a physical property of material 4 to be measured based on a current flowing through element 3 for physical property measurement as a result of the voltage applied. Measurer 2 measures a polarity of ions contained in material 4 to be measured.

According to this, there is provided an advantage of being able to measure the polarity of the ions contained in material 4 to be measured, which is a solid.

In physical property measurement system 100 according to the present disclosure, measurer 2 further measures an amount of the ions contained in material 4 to be measured.

According to this, there is provided an advantage of being able to measure the amount of the ions contained in material 4 to be measured, which is a solid.

Element 3 for physical property measurement according to the present disclosure is used in physical property measurement system 100.

According to this, there is provided an advantage of being able to measure the polarity of the ions contained in material 4 to be measured, which is a solid, by using element 3 for physical property measurement.

### INDUSTRIAL APPLICABILITY

The present disclosure can be applied, for example, to methods and systems for measuring physical properties of a material to be measured.

### REFERENCE SIGNS LIST

1 voltage applier
2 measurer
21 I-V converter
22 voltmeter
3 element for physical property measurement
31 insulation layer
32, 33 electrode
34 glass substrate
4 material to be measured
40 sample
100 physical property measurement system
300 element for physical property measurement according to comparative example
301 seal material
302, 303 insulation film
304, 305 electrode
306, 307 glass substrate

1. A physical property measurement method comprising:
applying a voltage between a pair of electrodes in an element for physical property measurement, the voltage periodically varying and periodically reversing in polarity, the element for physical property measurement including:
a material to be measured, the material being a solid;
an insulation layer disposed on only one of both sides of the material to be measured in a thickness direction of the material to be measured; and
the pair of electrodes between which the material to be measured and the insulation layer are interposed in the thickness direction; and
measuring a physical property of the material to be measured based on a current flowing through the element for physical property measurement as a result of the applying of the voltage,
wherein the measuring of the physical property of the material to be measured includes measuring a polarity of an ion contained in the material to be measured.

2. The physical property measurement method according to claim 1,
wherein the measuring of the physical property of the material to be measured further includes measuring an amount of the ion contained in the material to be measured.

3. The physical property measurement method according to claim 1,
wherein the applying of the voltage between the pair of electrodes is performed at a temperature higher than room temperature.

4. A physical property measurement system comprising:
a voltage applier that applies a voltage between a pair of electrodes in an element for physical property measurement, the voltage periodically varying and periodically reversing in polarity, the element for physical property measurement including:
a material to be measured, the material being a solid;
an insulation layer disposed on only one of both sides of the material to be measured in a thickness direction of the material to be measured; and
the pair of electrodes between which the material to be measured and the insulation layer are interposed in the thickness direction; and
a measurer that measures a physical property of the material to be measured based on a current flowing through the element for physical property measurement as a result of the voltage applied,
wherein the measurer measures a polarity of an ion contained in the material to be measured.

5. The physical property measurement system according to claim 4,
wherein the measurer further measures an amount of the ion contained in the material to be measured.

6. An element for physical property measurement, the element being used in the physical property measurement system according to claim 4.
